(19) United States
(12) Patent Application Publication
(10) Pub. No.: US 2012/0299719 A1
(43) Pub. Date: Nov. 29, 2012

(54) Portable traffic warning device

(76) Inventor: Chin-Hung Wu, Changhua (TW)

(21) Appl. No.: 13/115,945

(22) Filed: May 25, 2011

(51) Int. Cl. B60Q 1/26

(52) U.S. Cl. 340/468

(57) ABSTRACT

A portable traffic warning device releasably mounted on the underside of a lift gate of an automobile includes, in combination three elongated members set up in a triangular shape having a triangular hollow therethrough; a support leg pivotably secured to an upper central portion on a rear surface of the elongated members; a plurality of lamps arranged as a triangle on a front surface of the elongated members; and a rechargeable battery and controller mounted on the rear surface of the elongated members, the rechargeable battery and controller being electrically connected to an automotive battery of the automobile; wherein the lamps are controlled by the rechargeable battery and controller to operate in a first mode of continuously emitting light or a second mode of flashing.

### BACKGROUND OF THE INVENTION

1. Field of the Invention

The invention relates to safety signs and more particularly to a portable traffic warning device disposed in the lift gate of a motor vehicle when not in use and being detachable to rest upon the ground besides or in rear of the vehicle for attracting the attention of approaching drivers and warning them of a dangerous condition ahead.

2. Description of Related Art

A conventional portable traffic warning sign is shown in FIG. 1 and comprises a hollow triangle A having three light reflective regions B along three edges respectively, and a support leg pivotably secured to a rear surface of the triangle A. The traffic warning sign is typically stored in the lift gate of a car.

A driver may remove the traffic warning sign and rest same upon the ground beside, in front of, or in rear of the car after the car breaking down for attracting the attention of approaching drivers and warning them of a dangerous condition ahead.

However, it is only effective when the light reflective regions B are struck by light. This, however, means that it is useless in a dark environment such as mountains, deserts, etc. In brief, this is a passive safety design. Thus, the need for improvement still exists.

### SUMMARY OF THE INVENTION

It is therefore one object of the invention to provide a portable traffic warning device releasably mounted on the underside of a lift gate of an automobile comprising, in combination three elongated members set up in a triangular shape having a triangular hollow therethrough; a support leg pivotably secured to an upper central portion on a rear surface of the elongated members; a plurality of lamps arranged as a triangle on a front surface of the elongated members; and a rechargeable battery and controller mounted on the rear surface of the elongated members, the rechargeable battery and controller being electrically connected to an automotive battery of the automobile; wherein the lamps are controlled by the rechargeable battery and controller to operate in a first mode of continuously emitting light or a second mode of flashing.

The above and other objects, features and advantages of the invention will become apparent from the following detailed description taken with the accompanying drawings.

### BRIEF DESCRIPTION OF THE DRAWINGS

FIG. 1 is a perspective view of a typical traffic warning sign;

FIG. 2 is a perspective view of a portable traffic warning device according to the invention viewed from the rear;

FIG. 3 is another perspective view of FIG. 2 viewed from the front;

FIG. 4 schematically depicts the portable traffic warning device mounted on the underside of the lift gate of a car;

FIG. 5 is a perspective view showing an unlocking of the lift gate and a pivotal pulling of the lift gate for exposing the portable traffic warning device;

FIG. 6 is an enlarged view of FIG. 5 for showing an illumination of the lamps in one configuration;

FIG. 7 schematically shows a flashing of the lamps in another configuration;

FIG. 8 schematically shows how to remove the portable traffic warning device from the lift gate;

FIG. 9 shows the portable traffic warning device being removed from the lift gate and rested on a road surface besides the car; and

FIG. 10 shows the portable traffic warning device being removed from the lift gate and rested on a road surface rearward of the car.

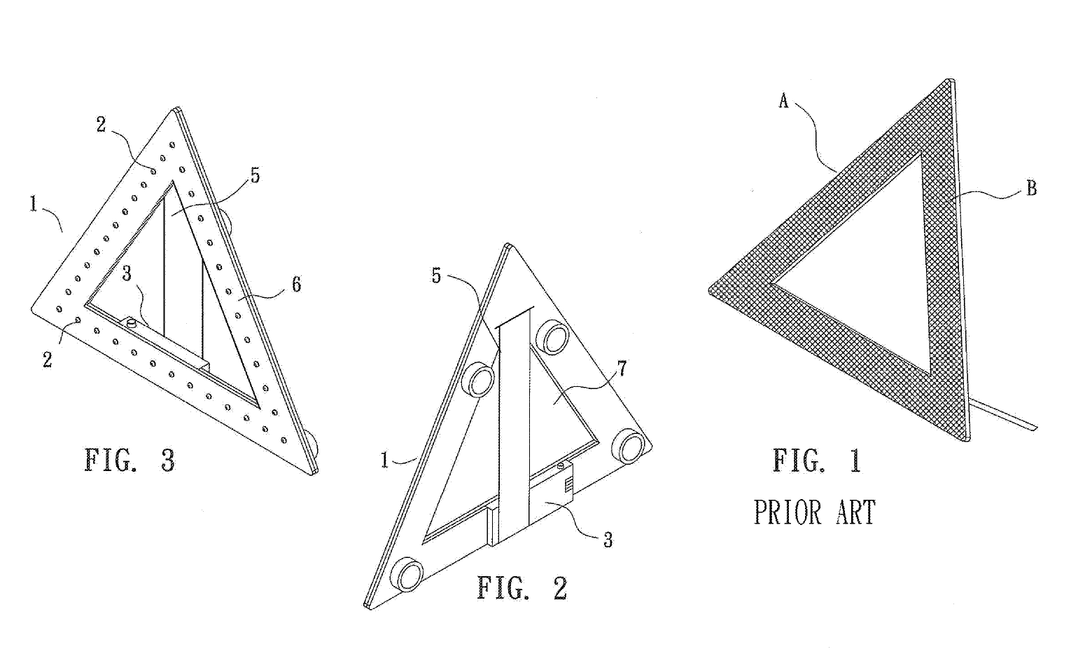

### DETAILED DESCRIPTION OF THE INVENTION

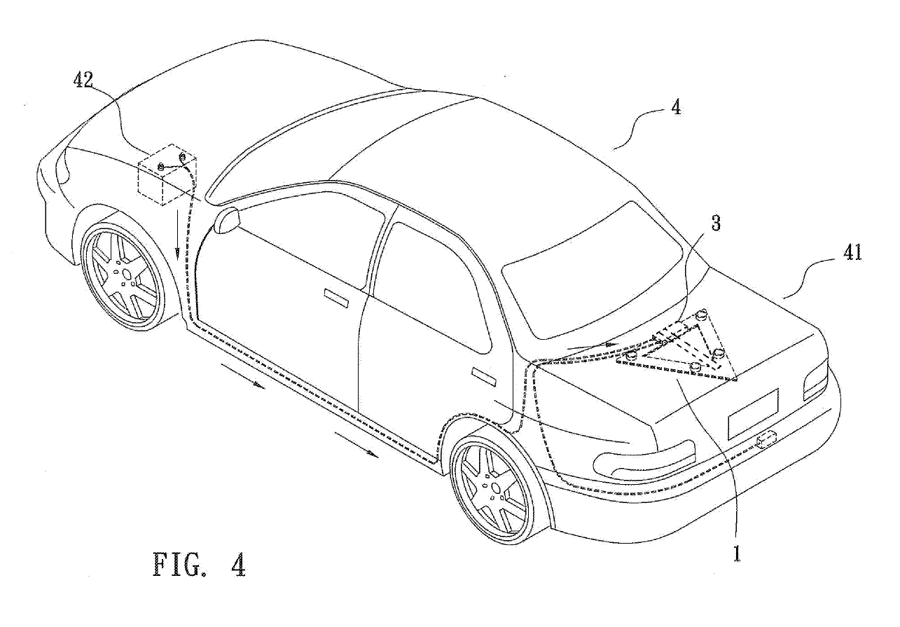

Referring to FIGS. 2 to 10, a portable traffic warning device 1 in accordance with the invention is releasably mounted on the underside of a lift gate 41 of a car 4. The traffic warning device 1 comprises the following components as discussed in detail below.

Three elongated members 6 which can be set up in a triangular configuration with a triangular hollow 7 therethrough.

A plurality of lamps 2 are arranged as a triangle along middle lines of a front surface of the elongated members 6. A support leg 5 is pivotably secured to an upper central portion on a rear surface of the elongated members 6. The support leg 5 can be pivoted to engage with the rear surface of the elongated members 6 when not in use or pivoted in an opposite direction to dispose on a road surface when in use.

A rechargeable battery and controller 3 is mounted on the rear surface of a horizontal one (i.e., base) of the elongated members 6. The rechargeable battery and controller 3 is electrically connected to an automotive battery 4 disposed under the hood. The automotive battery 4 can supply electric energy to the rechargeable battery and controller 3 for charging if the rechargeable battery and controller 3 is discharged. The charging can be stopped automatically if the rechargeable battery and controller 3 is charged.

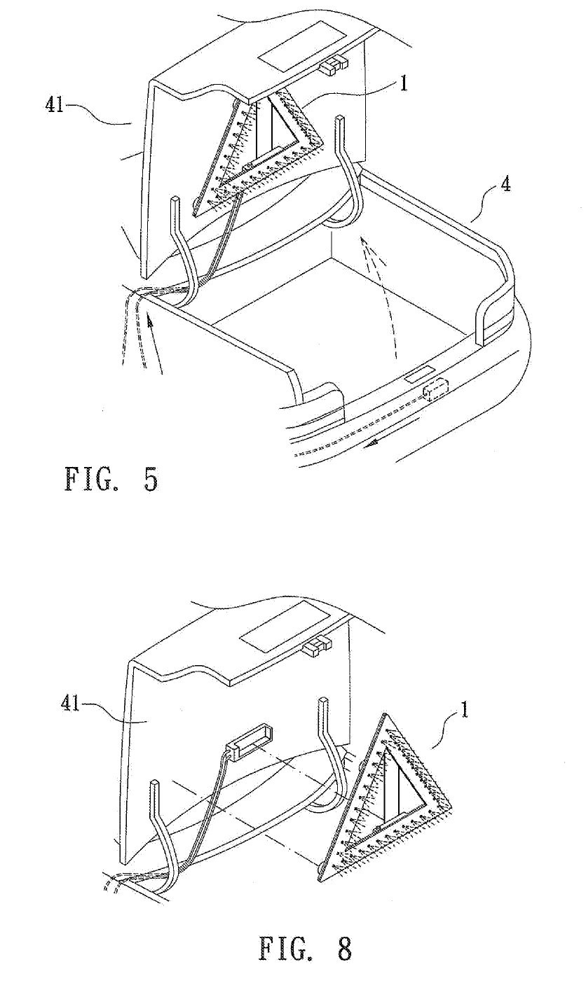

After experiencing a break down, a driver of the car 4 may unlock the lift gate 41 and pivotally pull the lift gate 41 to expose and activate the portable traffic warning device 1 for attracting the attention of approaching drivers and warning them of a dangerous condition ahead (see FIG. 5).

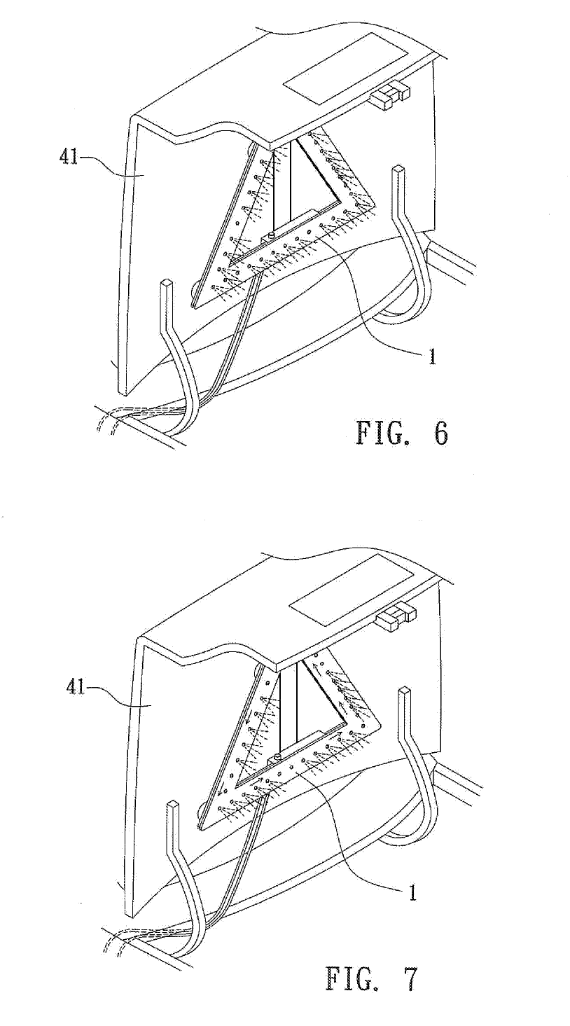

The rechargeable battery and controller 3 can be configured to set the lamps 2 to operate in one mode of continuously emitting light (see FIG. 6) or the other mode of flashing (see FIG. 7).

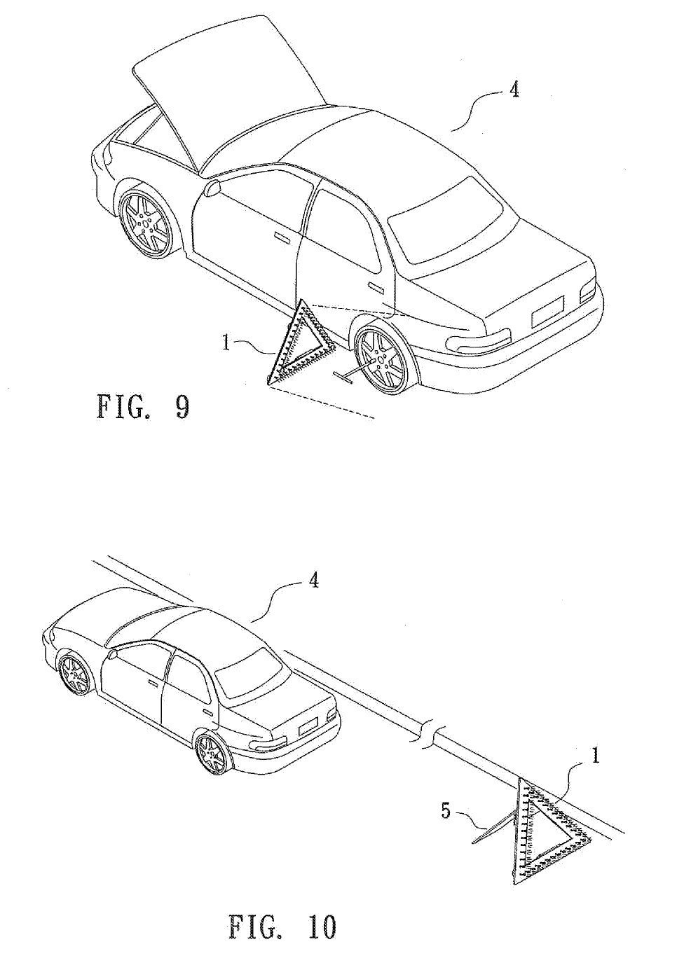

Alternatively, the driver may remove the portable traffic warning device 1 from the lift gate 41 (see FIG. 8). Next, the driver may place the traffic warning device 1 besides the car 4 (see FIG. 9) or on a road surface rearward of the car 4 (see FIG. 10) for attracting the attention of approaching drivers and warning them of a dangerous condition ahead.

While the invention has been described in terms of preferred embodiments, those skilled in the art will recognize that the invention can be practiced with modifications within the spirit and scope of the appended claims.

What is claimed is:

1. A portable traffic warning device releasably mounted on the underside of a lift gate of an automobile comprising, in combination:
three elongated members set up in a triangular shape having a triangular hollow therethrough;
a support leg pivotably secured to an upper central portion on a rear surface of the elongated members;
a plurality of lamps arranged as a triangle on a front surface of the elongated members; and
a rechargeable battery and controller mounted on the rear surface of the elongated members, the rechargeable battery and controller being electrically connected to an automotive battery of the automobile;
wherein the lamps are controlled by the rechargeable battery and controller to operate in a first mode of continuously emitting light or a second mode of flashing.
